(19) United States
(12) Patent Application Publication
(10) Pub. No.: US 2026/0289723 A1
(43) Pub. Date: Sep. 24, 2026

(54) CONSTRUCTING TRAINING DATA FOR MACHINE LEARNING MODEL OF GAME IMAGES

(71) Applicants: ADVANCED MICRO DEVICES, INC., Santa Clara, CA (US); ATI TECHNOLOGIES ULC, MARKHAM (CA)

(72) Inventors: Adam Grygielski, Wroclaw (PL); Benjamin Coquelle, London (GB); Rodrigo Andres Urra, Powell, OH (US); Can Alper, Boston, MA (US); Denis Leonard Levesque, Toronto (CA); Nathaniel Alexander High, Boston, MA (US)

(21) Appl. No.: 19/086,311

(22) Filed: Mar. 21, 2025

(51) Int. Cl. G06T 3/40; A63F 13/52; G06T 1/20; G06T 1/60

(52) U.S. Cl. CPC G06T 3/40; A63F 13/52; G06T 1/20; G06T 1/60

(57) ABSTRACT

Captured information representing one or more frames rendered by a game engine is accessed, e.g., by a processing unit. The captured information includes commands and memory content for instructing a graphics processing unit (GPU) to replay the frames represented by the captured information. One or more locations in a memory associated with the GPU are configured to store bits that represent jitter applied to the one or more frames by the game engine. These locations are identified, e.g., by the processing unit, which instructs the GPU to generate one or more modified frames by replaying the one or more frames based on the captured information and one or more modified values of the jitter. A resolution of the one or more frames then modified based on the one or more frames.

### BACKGROUND

Video games attempt to foster or instill a sense of immersion so that players feel that they are playing in the world of the game. Characteristics of games that facilitate immersion can be grouped into two general categories: those that create a rich mental model of the game environment and those that create consistency between the things in that environment. Elements of video game presentation that support a rich mental model include providing multiple channels of sensory information, completeness of the sensory information, cognitively demanding environments, and a strong and interesting narrative, plot, or story. Elements that create consistency include a lack of incongruous visual cues in the game world, consistent behavior from things in the game world, an unbroken presentation of the game world, and interactivity with items in the game world.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that generates sets of low-resolution input images and corresponding high-resolution ground truth images based on frames rendered by a gaming engine, according to some embodiments.

FIG. 2 illustrates a portion of a processing system that is configured to generate and store commands and memory content or rendering frames, according to some embodiments.

FIG. 3 illustrates a portion of a processing system that is configured to replay images or frames based on captured information, according to some embodiments.

FIG. 4 illustrates example training data that is generated by applying modified jitter to captured information that represents a source image generated by a game engine, according to some embodiments.

FIG. 5 illustrates an example pattern of jitter that is applied to an image provided by a game engine and a pattern of jitter that is applied to replayed versions of the image, according to some embodiments.

FIG. 6 illustrates a method of generating modified versions of a source image that are used to form a high-resolution, ground truth image, according to some embodiments.

FIG. 7 illustrates an example pattern of jitter that is applied to replayed versions of the image, according to some embodiments.

FIG. 8 illustrates a method of generating modified versions of a source image that are used to form a set of low-resolution images from a source image, according to some embodiments.

FIG. 9 illustrates an example of jitter applied to pixels in a low-resolution version and a higher resolution version of a source image, according to some embodiments.

FIG. 10 illustrates an example of additional jitter applied to pixels prior to forming a low-resolution version of a source image by sampling pixels in a high-resolution version of the source image, according to some embodiments.

### DETAILED DESCRIPTION

Spatial aliasing and other distracting artifacts in video images can disrupt a viewer’s sense of immersion in the scene represented by the images. For example, the Moiré effect can produce artificial patterns in highly detailed textures. Moiré patterns can generate distracting flickering that is incongruous and inconsistent with a player’s expectations and therefore tends to break immersion. Gaming engines therefore support temporal anti-aliasing (TAA) techniques that reduce visual artifacts by leveraging information from multiple frames over time. Conventional TAA techniques leverage information in previous frames to smooth edges and improve image stability, which is useful in dynamic scenes with movement. Conventional TAA techniques do not utilize machine learning (ML) processes, at least in part because data needed to train ML models is not available. For example, training an ML model to perform upscaling requires low resolution input images and high-resolution output images of the same scene. Indeterminacies in the gaming engine make it difficult to render the same scene in different resolutions in a manner that can be used to train ML models. For example, particle contamination may lead to difficulties in matching objects between the images rendered at different resolutions. Independently rendered images at different resolutions are therefore inappropriate for training ML algorithms.

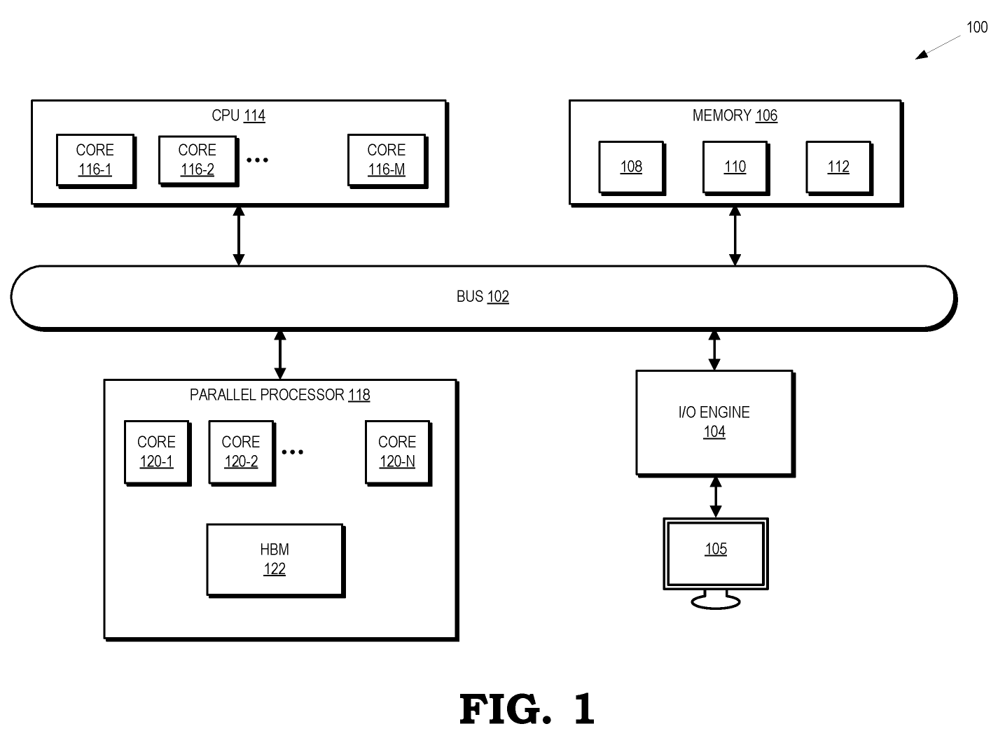

FIGS. 1-10 illustrate methods, apparatuses, and systems that are configured to construct low resolution input images and corresponding high-resolution ground truth images that can be used to train an ML model to perform upscaling operations, e.g., on image frames produced by a gaming engine. Note that references to gaming engines also refer to rendering engines for other interactive and/or immersive experiences besides/in addition to video gaming, unless otherwise mentioned. To generate the training data, a processing unit (e.g., a central processing unit (CPU) or a graphics processing unit (GPU)) accesses a capture file that contains information representing one or more frames that were rendered by a game engine. The captured information includes GPU commands and memory content that can be used to replay the captured frames by providing the GPU commands and memory content to a GPU, which can be the same or different than the processing unit that captured the information. Thus, the captured frames can be deterministically replayed by the GPU.

The memory content of the captured information includes information representing jitter that is applied to generate visual effects by shifting the camera perspective used to render the captured frames. During rendering, the magnitude and direction of the jitter is stored in a predetermined location in GPU memory, although the location can differ depending on the game, the game engine, or properties of the GPU. The processing unit can identify, based on the captured information, the locations in the GPU memory that are used to store bits that represent jitter. For example, the processing unit can identify the location(s) based on characteristics of shader code provided by the game engine, data shown by a graphics debugger operating on the captured information, characteristics of the captured GPU commands, or a combination thereof. Once the processing unit has determined the locations, the processing unit can instruct the GPU to replay the workload based on the captured information and modified jitter values. For example, in response to receiving the instructions, the GPU stores the original jitter values in the corresponding locations in the GPU memory. The processing unit can then issue memory modification commands to modify the locations in the GPU memory with modified values of the jitter so that the GPU renders the one or more frames based on the modified jitter. This process can be iterated over a plurality of different modified jitter values.

A set of low-resolution input images and a corresponding high-resolution ground truth image are generated by replaying a workload (e.g., replaying a workload to produce an image representing frame generated by a gaming engine) using modified values of the jitter to create one or more modified images. The processing unit can combine the modified images to increase the resolution of the source image (e.g., to produce a ground truth image) or decrease the resolution of the source frame to produce a set of input images at lower resolutions. To generate the ground truth image at a high resolution (e.g., 15360 × 8640, also known as 16K), the processing unit applies different modified jitters to the GPU memory that is referenced while rendering the source image to generate multiple images corresponding to different perspectives of a scene. The processing unit can combine the images to generate the high-resolution ground truth image of the scene because of the sub-pixel-level shifts created by the different jitter values. This results in a high-quality ground truth image that can be superior to upscaled images created by the original game engine. If necessary, the high-resolution ground truth images are down sampled to correspond to existing display resolutions. Down sampling can be performed by averaging 4 x 4 sets of pixels to form a single pixel having the average value.

To generate a set of input images at lower resolutions (relative to the source image), the processing unit determines a sequence of jitter values (such as a Halton sequence of values) to apply to a corresponding sequence of images. For example, the processing unit can select a first jitter value from the Halton sequence and apply the first jitter value to a first frame. The processing unit can select pixels from the high-resolution source image of the first frame and combine the selected pixels to construct a low-resolution version of the source image. A second jitter value can be applied to a second frame, a third jitter value can be applied to a third frame, etc., to generate the set of input images. If the source images are evenly divided into the resolution of the target image (e.g., when reducing the resolution from 7680x4320 (8k) to 1920x1080 (2k)), then there is a direct mapping between the pixels in the high-resolution source image and the pixels in the low-resolution image. If the source images do not evenly divide into the resolution of the target image (e.g., when reducing the resolution from 7680x4320 to 2304x1296), then there is no direct mapping between the pixels in the source images and the pixels in low-resolution images. In that case, the processing unit applies an additional jitter to shift the source image so that the pixels in the modified source image map to the pixels in the low-resolution image. The processing unit can then combine the pixels in the modified source image to construct the low-resolution version of the source image.

FIG. 1 is a block diagram of a processing system 100 that generates sets of low-resolution input images and corresponding high-resolution ground truth images based on frames rendered by a gaming engine, according to some embodiments. The low-resolution input images and corresponding high-resolution ground truth images can be used to train an ML engine. For example, the ML engine can be trained to generate the high-resolution ground truth image in response to receiving the low-resolution image as input. Once the ML engine has been trained, the ML engine is used to perform TAA and upscale low-resolution images that are provided to the ML engine.

The processing system 100 includes a bus 102 implemented with circuitry that supports communication between entities implemented in the processing system 100. Some implementations of the processing system 100 include other buses, bridges, switches, routers, and the like, which are not shown in FIG. 1 in the interest of clarity. An input/output (I/O) engine 104 is implemented with circuitry that handles input or output operations associated with display 105, as well as other elements of the processing system 100 such as keyboards, mice, printers, external disks, and the like. The I/O engine 104 is coupled to the bus 102 so that the I/O engine 104 can communicate with other entities in the processing system 100 by exchanging signals over the bus 102.

Processing system 100 also includes or has access to a memory 106 or other storage component including circuitry that implements a non-transitory computer-readable medium such as a dynamic random-access memory (DRAM). However, some embodiments of memory 106 are implemented using other types of memory including, for example, static random-access memory (SRAM), nonvolatile RAM, and the like. Some embodiments of memory 106 include an external memory implemented external to the processing units implemented in the processing system 100. Memory 106 can store information representing instructions such as program code 108 for one or more applications (e.g., graphics applications, compute applications, machine learning applications), data 110 that is consumed by the program code 108, and results 112 produced by executing the program code 108.

The processing system 100 includes a central processing unit (CPU) 114 that is connected to the bus 102 to communicate with other entities in the processing system 100, such as the I/O engine 104, memory 106, or other entities connected to the bus 102. The terms “processing unit” and “processor” are used interchangeably herein. The CPU 114 is implemented with circuitry including a plurality of processor cores 116-1, 116-2, ... 116-N that execute instructions concurrently. Although three processor cores 116 are shown in FIG. 1, more or fewer processor cores 116 can be implemented in other embodiments of the CPU 114. The processor cores 116 include circuitry to implement one or more compute units such as single-instruction, multiple data (SIMD) units that perform the same operation on different data sets to produce one or more results. The CPU 114 is configured to execute instructions such as the program code 108 for one or more applications, which is stored in memory 106. The CPU 114 can consume data 110 and store information in memory 106 such as the results 112 of the executed instructions.

The processing system 100 also includes a parallel processor 118. The parallel processor 118 can include, for example, a GPU, a general-purpose GPU (GPGPU), a neural processing unit (NPU), an intelligence processing unit (IPU) or other vector processor or type of parallel processor. The parallel processor 118 includes circuitry to implement one or more processor cores 120-1...M that each operate as a compute unit configured to perform one or more operations based on one or more instructions received by the parallel processor 118. Although three processor cores 120 are shown in FIG. 1, more or fewer processor cores 120 can be implemented in other embodiments of the parallel processor 118. The compute units in the processor cores 120 are implemented as circuitry for one or more single-instruction, multiple data (SIMD) units that perform the same operation on different data sets to produce one or more results.

In the illustrated embodiment, the parallel processor 118 includes circuitry for storing data such as one or more high bandwidth memories (HBM) 122 that are used to store instructions or data that are accessed by one or more of the processor cores 120 via high bandwidth connections (not shown in FIG. 1 in the interest of clarity). Some embodiments of the HBM 122 store instructions or information that has been retrieved or fetched from memory 106. For example, instructions can be fetched from the program code 108 and stored in HBM 122 and data can be fetched from the data 110 and stored in the HBM 122. Although the HBM 122 is shown internal to the parallel processor 118 and external to the processor cores 120, some embodiments of the processor cores 120 include additional, internal HBM or caches and some embodiments of the HBM 122 are implemented external to the parallel processor 118.

The HBM 122 can store information that represents one or more frames rendered by a game engine. For example, the processing system 100 can implement a game engine that renders frames for a game using resources of the CPU 114, the parallel processor 118, or a combination thereof. Information representing one or more of the rendered frames is captured and stored in memory 106, the HBM 122, or a combination thereof. The captured information includes commands and memory content for instructing the parallel processor 118 (or other GPU) to replay the frames. The memory content in the captured information includes information representing jitter applied to the frames. Camera jittering is a technique that game engines employ to slightly shift the camera and achieve special effects. The game engine stores the direction and magnitude of the jitter in the HBM 122 or the memory 106. The original jitter generated by the gaming engine can therefore be detected in the captured information, e.g., by identifying memory locations used to store the jitter. Modified replays of the corresponding frames can be generated by modifying the original jitter in the captured information. The modified replays can then be used to create higher or lower resolution versions of the frames rendered by the gaming engine. As discussed herein, the higher and lower resolution versions can be used to train an ML engine to perform tasks such as upscaling of input images to higher resolutions.

Some embodiments of a processing unit (such as the CPU 114 or the parallel processor 118) are configured to identify one or more locations in a corresponding memory (such as the HBM 122) that is configured to store bits that represent jitter applied to corresponding frames in the captured information. The memory locations can be identified based on characteristics of shader code provided by the game engine, data shown by a graphics debugger operating on the captured information, characteristics of the captured commands, and/or other information. The processing unit instructs the parallel processor 118 (or other GPU) to generate one or more modified frames by replaying the frames represented by the captured information based on one or more modified values of the jitter, as well as other portions of the captured information. The processing unit can then modify a resolution of the frame(s) based on the modified frame(s). Modifying the resolution of the frames can include generating a set of low-resolution input images based on a sequence of jitter values, generating a high-resolution ground truth image based on a sequence of jitter values, or a combination thereof.

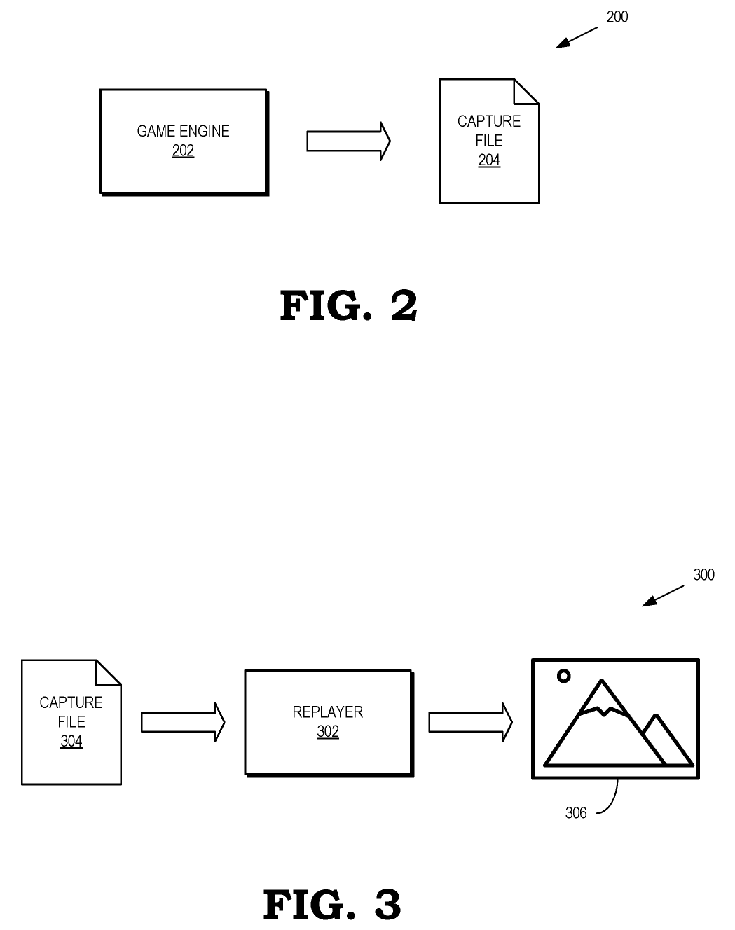

FIG. 2 illustrates a portion 200 of a processing system that is configured to generate and store commands and memory content or rendering frames, according to some embodiments. The portion 200 of the processing system is implemented in some embodiments of the processing system 100 shown in FIG. 1. In the illustrated embodiment, the portion 200 includes a game engine 202 that is implemented with circuitry configured to render images that represent frames such as frames of the video game. For example, the game engine 202 can generate commands that instruct a processing unit such as the parallel processor 118 shown in FIG. 1 to perform operations on graphics elements such as primitives, vertices, triangles, and the like. The game engine 202 can also issue application programming interface (API) calls, memory allocation commands, and the like.

Some embodiments of the game engine 202 perform multiple render passes to render images that represent frames displayed by the video game. The render passes are implemented using one or more shaders. For example, the game engine 202 can construct a frame using a first render pass to render objects in the scene, a second render pass to render special effects that are applied to the objects in the scene, a third render pass to render shadows cast by (or on) the objects in the scene, as well as one or more additional render passes to add other visual features to the rendered image. The game engine 202 also applies jitter to the rendered images. The jitter translates the image by a predetermined magnitude and direction in the plane of the image, which corresponds to modifying the perspective or viewpoint of the camera that is viewing the scene. In some embodiments, once the frame is complete, the game engine 202 can perform a render pass to upscale the image of the scene, e.g., to a resolution of 8K, to form a source image. The game engine 202 can also perform additional render passes to perform postprocessing and finalization operations such as tone mapping.

A processing unit (such as the CPU 114 or the parallel processor 118 shown in FIG. 1) captures the information generated by the game engine 202 and stores the captured information in a capture file 204. As discussed herein, the captured information includes information indicating values of the jitter applied to the image. The jitter information is stored in sets of bits at predetermined locations in a memory used by the processing unit, such as the HBM 122 shown in FIG. 1. For example, the jitter that is applied to an image or frame can be encoded in one or more model view projection matrices that are stored in the memory associated with processing unit. The captured information saved in the capture file 204 can be used to “replay” a frame and reproduce the source image. Thus, there is no indeterminacy between the original source image and replayed versions of the source image.

FIG. 3 illustrates a portion 300 of a processing system that is configured to replay images or frames based on captured information, according to some embodiments. The portion 300 of the processing system is implemented in some embodiments of the processing system 100 shown in FIG. 1. The portion 300 includes a replayer 302 that is implemented using circuitry configured to read commands and memory content stored in a capture file 304. The replayer 302 can then render a frame or image 306 based on the captured information in the capture file 304. As discussed herein, the capture file 302 includes the commands and memory content generated by a game engine (such as the game engine 202 shown in FIG. 2) to instruct a GPU to generate a source image. The image 306 produced by the replayer 302 is the same as the original source image, although a different jitter can be applied.

The replayer 302 can also modify the commands or memory content in the capture file 302 prior to generating the image 306 so that the image 306 is a modified version of the original source image. In the illustrated embodiment, the replayer 302 can modify the jitter that was applied to the original source image. The replayer 302 identifies one or more GPU memory locations that are configured to store bits that represent jitter applied to a frame or image by the game engine. The memory locations can be determined based on characteristics of the stored information such as characteristics of shader code provided by the game engine, data shown by a graphics debugger operating on the captured information, or characteristics of the captured commands. Based on the identified memory locations, the replayer 302 determines the location of the jitter information within the GPU memory. The replayer 302 can then generate the image 306 as a modified version of the source image by replaying the information in the capture file 304 based on modified values of the jitter. For example, the replayer 302 can issue memory modification commands to modify the contents at the identified GPU memory locations so that the original jitter values are modified to new jitter values.

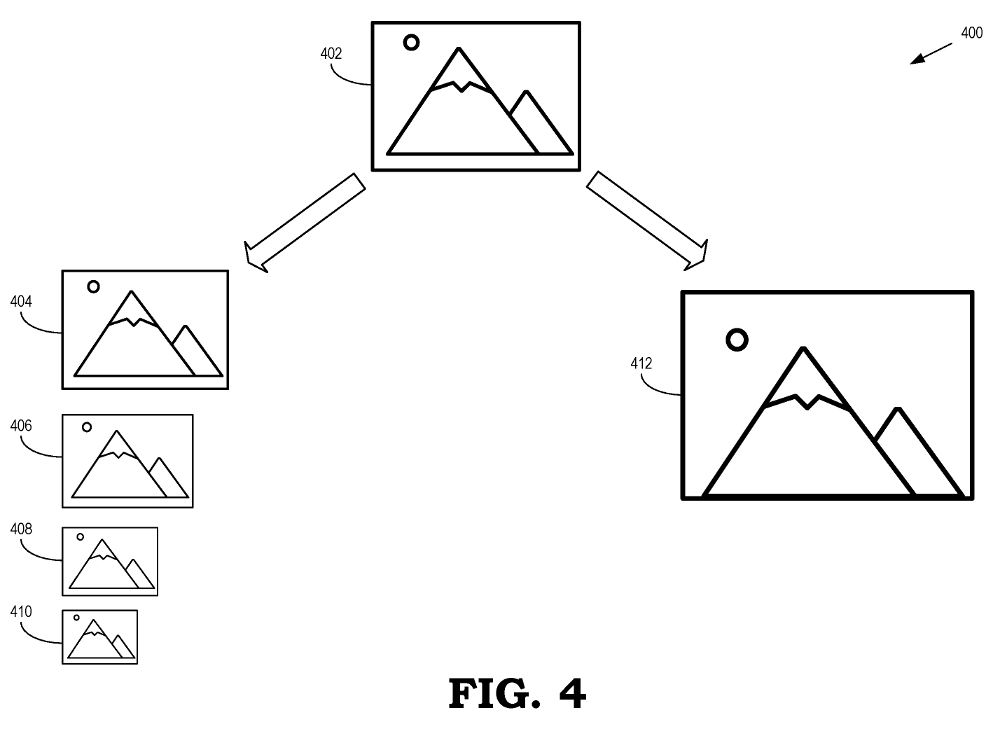

FIG. 4 illustrates training data 400 that is generated by applying modified jitter to captured information that represents a source image 402 generated by a game engine, according to some embodiments. The training data 400 can be generated by a processing unit such as the CPU 114 or the parallel processor 118 shown in FIG. 1. A training data 400 includes a set of low-resolution images 404, 406, 408, 410 that are generated by applying a sequence of jitters (such as a Halton sequence) to the source image 402. The set of low-resolution images 404, 406, 408, 410 can be used as input to a training algorithm that is configured to train an ML model, such as an ML model that is trained to upscale images. The training data 400 also includes a high-resolution, ground truth image 412 that is generated by combining images produced by applying a set of jitters to the source image 402. The high-resolution, ground truth image 412 can be used as a reference image that is compared to an output of the ML model during training of the ML model.

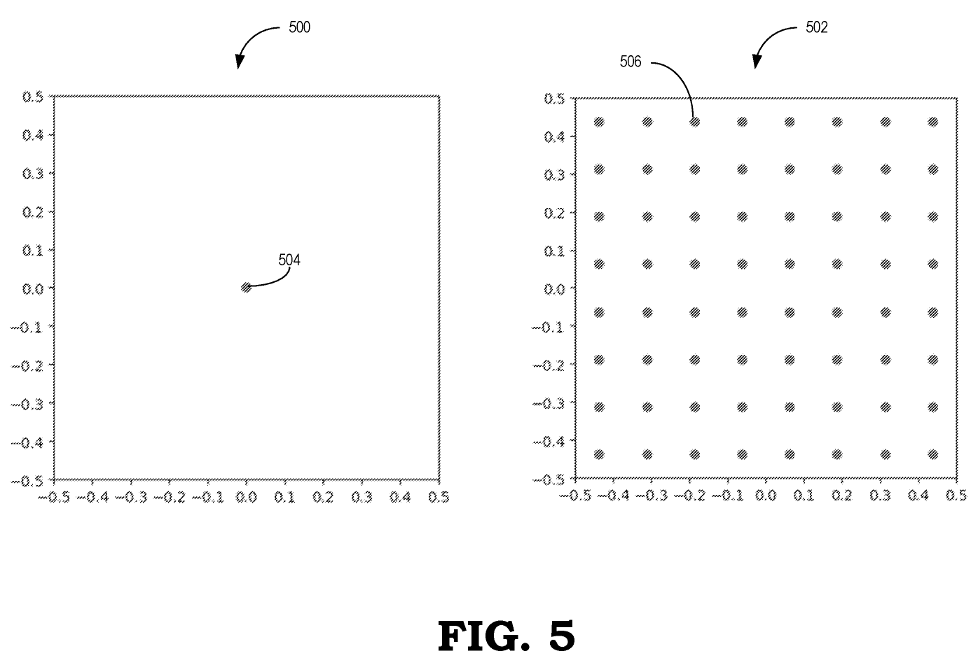

FIG. 5 illustrates a pattern 500 of jitter that is applied to an image provided by a game engine and a pattern 502 of jitter that is applied to replayed versions of the image, according to some embodiments. The pattern 500 shows a single value 504 of jitter that is applied to the image by the game engine. In the illustrated embodiment, the value 504 is equal to (0.0, 0.0) but the game engine can apply any value of jitter to the image. The pattern 502 is a uniform pattern of values 506 (only one indicated by a reference numeral in the interest of clarity) of jitter that can be applied to replayed versions of the image. As discussed herein, the values 506 are used to replace the value 504 when generating the replayed version of the image. For example, a processing unit can use memory modification commands to replace the value 504 with one of the values 506 during replays of the source image.

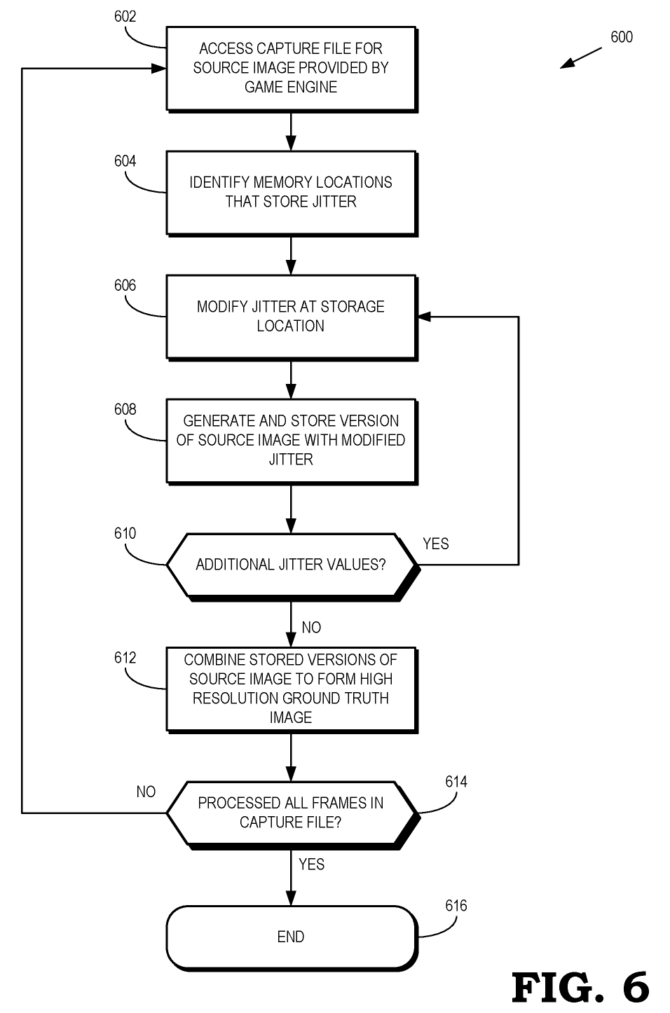

FIG. 6 illustrates a method 600 of generating modified versions of a source image that are used to form a high-resolution, ground truth image, according to some embodiments. The method 600 is implemented in a processing unit such as some embodiments of the CPU 114, the parallel processor 118 shown in FIG. 1, or the replayer 302 shown in FIG. 3. The processing unit includes, or is associated with, a memory such as the HBM 122 or the memory 106 shown in FIG. 1. The memory stores captured information including commands and memory content that can be provided to a GPU (or other processing unit) to generate images or frames for a videogame. For example, the memory can store copies of the capture file 204 shown in FIG. 2 or the capture file 304 shown in FIG. 3.

At block 602, the processing unit accesses the capture file including captured information representing commands and memory content used to generate a source image. As discussed herein, the capture file is created based on information provided by a game engine.

At block 604, the processing unit identifies locations in the memory that store bits representing values of jitter that is applied to the source image by the game engine. As discussed herein, the processing unit can identify the locations based on shader code characteristics, graphics debugger data, characteristics of the captured commands, or a combination thereof.

At block 606, the processing unit modifies the value of the jitter that was applied to the source image by the game engine. In some embodiments, the processing unit issues memory modification commands to modify the value of the jitter to a modified value during replay of the captured information. As discussed herein, the modified value of the jitter can be selected from a pattern or sequence or distribution such as the pattern 500 of jitter values shown in FIG. 5.

At block 608, the processing unit generates and stores a modified version of the source image that is generated based on the modified jitter. In some embodiments, the processing unit generates the modified version by replaying commands in the captured information including the commands and memory content used to generate the source image. Although the blocks 606 and 608 are shown as occurring sequentially, the operations performed in the blocks 606 and 608 can be performed in a different order or concurrently.

At decision block 610, the processing unit determines whether there are additional jitter values. For example, the processing unit can determine whether the source image has been replayed (based on the captured information) using all the values of the modified jitter in the pattern 500 of jitter values shown in FIG. 5. If there are additional jitter values, the method 600 flows to the block 606. If there are no additional jitter values, the method flows to the block 612.

At block 612, the processing unit combines the stored versions of the source image to form the high-resolution, ground truth image. Combining the modified versions of the source image produces the high-resolution image at least in part because of the sub-pixel-level shifts created by the different jitter values. This results in a high-quality ground truth image that can be superior to upscaled images created by the original game engine. If necessary, the processing unit down samples the high-resolution ground truth images to correspond to existing display resolutions. For example, the processing unit can perform down sampling by averaging 4 x 4 sets of pixels to form a single pixel having the average value.

At decision block 614, a processing unit determines whether all the frames in the capture file have been processed. If not, the method 600 flows back to block 602 and accesses information representing the next frame from the capture file. If the processing unit determines that all the frames in the capture file have been processed, the method 600 flows to the block 616 and ends.

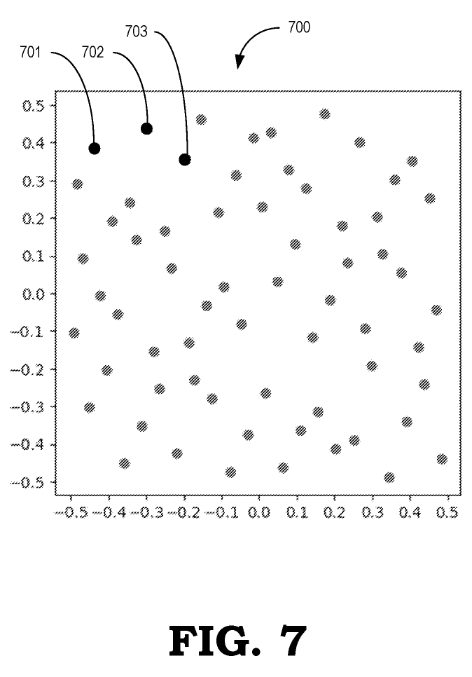

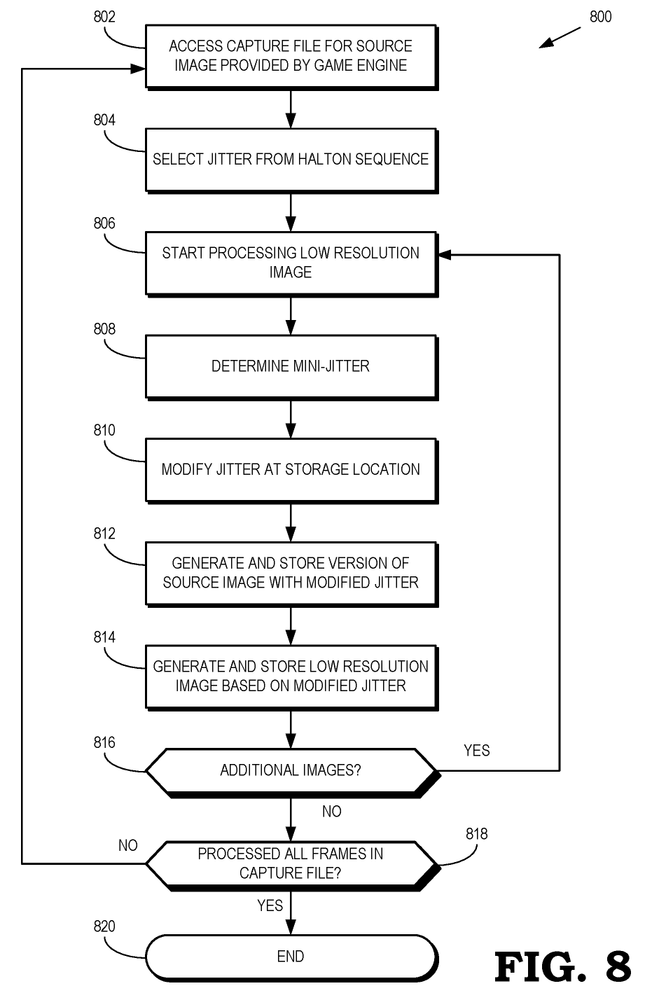

FIG. 7 illustrates a pattern 700 of jitter that is applied to replayed versions of the image, according to some embodiments. In the illustrated embodiment, the pattern 700 represents a Halton pattern, although other patterns or sequences can be used in other embodiments. The jitter values in the pattern 700 are applied in sequence to successive frames or images. For example, the value 701 can be applied to a first frame or image, the value 702 can be applied to a second frame or image, and the value 703 can be applied to a third frame or image. A sequence of replayed frames or images can therefore be generated based on the sequence of jitter values in the pattern 700. As discussed herein, memory modification commands and be used to replace the original jitter value in the source image with the values 701, 702, 703 when generating successive replayed versions of the source image.

FIG. 8 illustrates a method 800 of generating modified versions of a source image that are used to form a set of low-resolution images from a source image, according to some embodiments. The method 800 is implemented in a processing unit such as some embodiments of the CPU 114, the parallel processor 118 shown in FIG. 1, or the replayer 302 shown in FIG. 3. The processing unit includes, or is associated with, a memory such as the HBM 122 or the memory 106 shown in FIG. 1. The memory stores captured information including commands and memory content that can be provided to a GPU (or other processing units) to generate images or frames for a videogame. For example, the memory can store copies of the capture file 204 shown in FIG. 2 or the capture file 304 shown in FIG. 3.

At block 802, the processing unit accesses the capture file including captured information representing commands and memory content used to generate a source image. As discussed herein, the capture file is created based on information provided by a game engine. Although not specifically shown in the interest of clarity, the processing unit also determines, or receives information indicating, memory locations that store jitter applied to the source image by the game engine.

At block 804, the processing unit selects a value of jitter from a sequence such as a Halton sequence. For example, the processing unit can select the value 701 of the jitter from the Halton sequence indicated by the pattern 700 shown in FIG. 7.

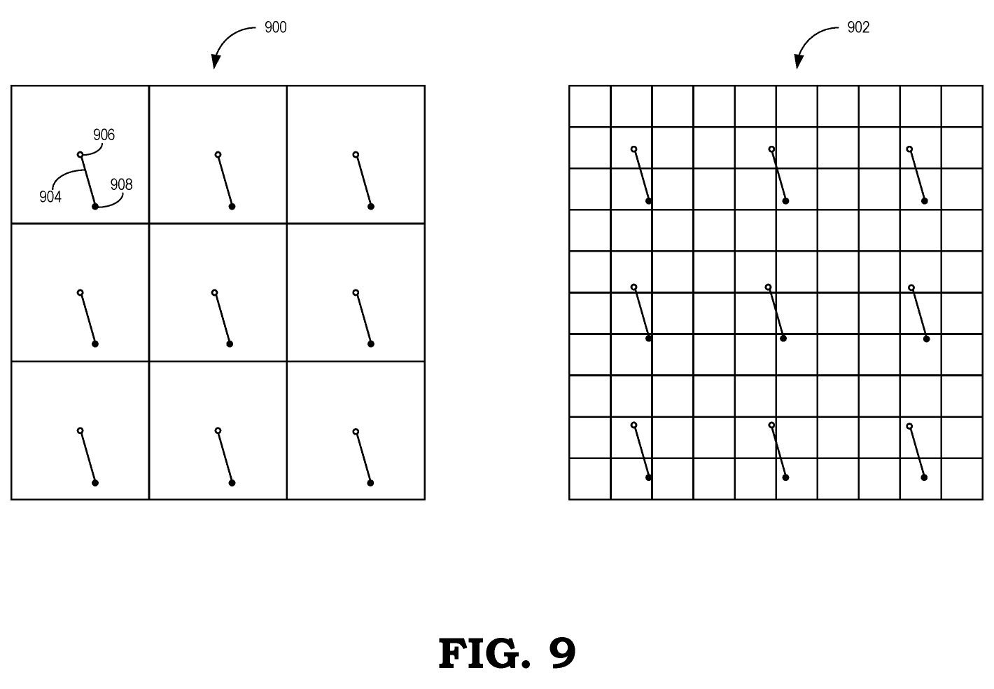

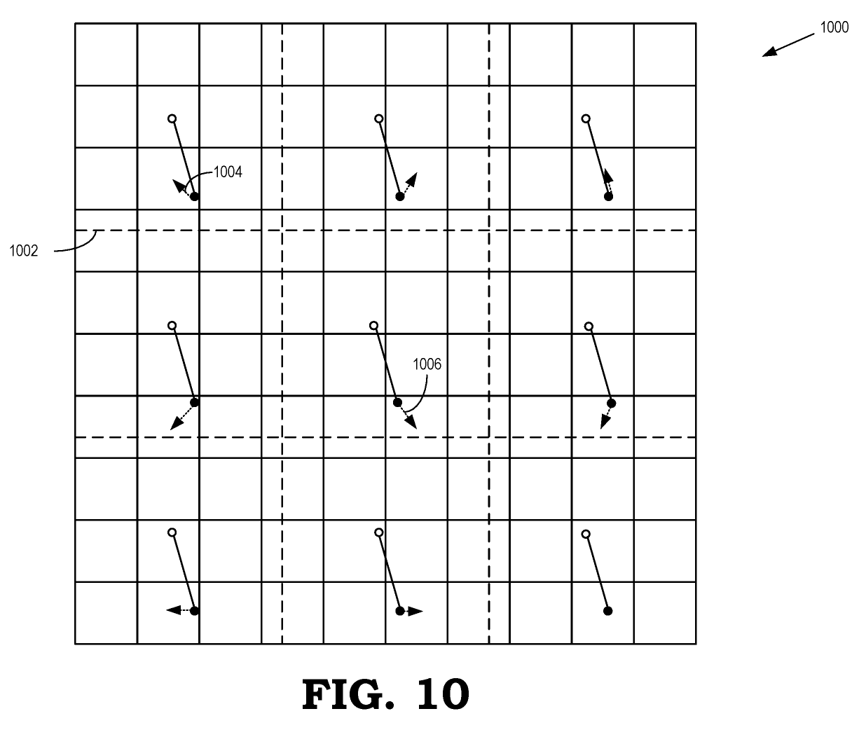

At block 806, the processing unit begins processing the low-resolution image based on the value of the jitter selected from the sequence. As discussed herein with regard to FIG. 9 in FIG. 10, sampling points in the low-resolution image are not necessarily at the centers of the pixels of the high-resolution version. To account for offsets between pixel centers in the high- resolution and low-resolution images, the processing unit can determine and add additional jitter (referred to herein as a “mini-jitter”) to the value of the jitter selected from the sequence. The mini-jitter is applied (at block 808) to account for sampling points in the low-resolution image that are not at the centers of the pixels of the high-resolution version.

At block 810, the processing unit modifies the value of the jitter that was applied to the source image by the game engine using the selected value of the jitter. In some embodiments, the processing unit issues memory modification commands to modify the value of the jitter to the selected value during replay of the captured information.

At block 812, the processing unit generates and stores a modified version of the source image that is generated based on the modified jitter. In some embodiments, the processing unit generates the modified version by replaying commands in the captured information used to generate the source image. Although blocks 810 and 812 are shown as occurring sequentially, the operations performed in the blocks 810 and 812 can be performed in a different order or concurrently.

At block 814, a processing unit generates and stores a low-resolution image based on the version of the source image that was replayed with a modified value of the jitter. To generate the low-resolution image, the processing unit selects pixels from the (high-resolution) modified version of the source image that was generated in block 812. A processing unit can then combine the selected pixels to construct the low-resolution version of the source image. If the resolution of the modified version of the source image evenly divides into the resolution of the low-resolution version, i.e., if the resolution of the modified version is an integer multiple of the resolution of the low-resolution version, then there is a direct mapping between the pixels in the high-resolution source image and the pixels in the low-resolution image. The direct mapping is used to combine the pixels of the high-resolution image to form the low-resolution image. If the source images do not evenly divide into the resolution of the target image, i.e., if the resolution of the modified version is a non-integer multiple of the resolution of the low-resolution version, then there is no direct mapping between the pixels in the source images and the pixels in low-resolution images. In that case, the processing unit applies an additional jitter to shift the source image so that the pixels in the modified source image are mapped to the pixels in the low-resolution image. The processing unit can then combine the pixels in the modified source image to construct the low-resolution version of the source image.

At decision block 816, the processing unit determines whether there are additional low-resolution images to generate. For example, the processing unit can be configured to generate the low-resolution images 404, 406, 408, 410 shown in FIG. 4. In that case, the method 800 is iterated four times with different values of the jitter is selected from the Halton sequence represented by the pattern 700 shown in FIG. 7. If there are additional low-resolution images to generate, method 800 flows to block 802. Otherwise, method 800 flows to decision block 818

At decision block 818, a processing unit determines whether all the frames in the capture file have been processed. If not, the method 800 flows back to block 802 and accesses information representing the next frame from the capture file. If the processing unit determines that all the frames in the capture file have been processed, the method 800 flows to the block 820 and ends.

FIG. 9 illustrates jitter applied to pixels in a low-resolution version 900 and a higher resolution version 902 of a source image, according to some embodiments. As discussed herein, the low-resolution version 900 of the source image can be generated by applying a jitter to the high-resolution version 902 of the source image and then combining pixels from the jittered high-resolution version 902. In the illustrated embodiment, jitter is indicated by a desired jitter 904, an open circle indicating a sample point 906 at the center of a pixel in the low-resolution version 900, and a filled circle indicating a desired sample point 908 for the pixel. Only one example of the desired jitter 904, the sample point 906, and the desired sample point 908 is indicated by a reference numeral in the interest of clarity.

In the illustrated embodiment, the resolution of the high-resolution version 902 does not evenly divide into the resolution of the low-resolution version 900, i.e., the resolution of the high-resolution version 902 is not an integer multiple of the resolution of the low-resolution version 900. For example, neither the sample point 906 at the tail of the desired jitter 904 that indicates the jitter and the desired sample point 908 at the head of the desired jitter 904 are located at the center of pixels in the high-resolution version 902. An additional jitter is therefore added to shift the high-resolution version 902 so that the low-resolution version 900 is generated by sampling from pixel centers in the high-resolution version 902.

FIG. 10 illustrates additional jitter applied to pixels prior to forming a low-resolution version of a source image by sampling pixels in a high-resolution version 1000 of the source image, according to some embodiments. The dashed lines 1002 indicate boundaries of pixels in the low-resolution version that is formed by sampling the pixels in the high-resolution version 1000. As discussed with regard to FIG. 9, applying a single jitter to all of the pixels in the high-resolution version 1000 results in sampling points (indicated by the filled circles) that are not at the centers of the pixels of the high-resolution version 1000. An additional jitter 1004, 1006 (only two indicated by reference numerals in the interest of clarity) is applied to the high-resolution version 1000 to shift or map the sampling points to the centers of pixels in the high-resolution version 1000. Since the resolution of the high-resolution version 1000 is not an integer multiple of the resolution of the low-resolution version of the source image, the magnitude and direction of the additional jitter 1004, 1006 can be different for different pixels. Consequently, the magnitude and direction of the additional jitter 1004, 1006 is determined on a per pixel basis. The additional jitter 1004, 1006 is applied (in conjunction with the jitter applied to all the pixels) prior to generating the modified, low-resolution version of the source image.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the embodiments disclosed above may be altered or modified and all such variations are considered within the scope of the disclosed subject matter. Accordingly, the protection sought herein is as set forth in the claims below.

What is claimed is:

1. A method comprising:
accessing captured information representing at least one frame rendered by a game engine, wherein the captured information comprises one or more commands and memory content for instructing a graphics processing unit (GPU) to replay the at least one frame;
identifying at least one location in a memory associated with the GPU and configured to store bits that represent jitter applied to the at least one frame by the game engine;
instructing the GPU to generate at least one modified frame by replaying the at least one frame based on the captured information and at least one modified value of the jitter; and
modifying a resolution of the at least one frame based on the at least one modified frame.

2. The method of claim 1, wherein the bits stored at the at least one location represent a magnitude and a direction of the jitter.

3. The method of claim 2, wherein identifying the at least one location in the memory comprises identifying the at least one location based on at least one of a characteristic of shader code provided by the game engine, data shown by a graphics debugger operating on the captured information, or a characteristic of a captured command.

4. The method of claim 2, wherein replaying the at least one frame comprises issuing at least one memory modification command to modify the bits stored at the at least one location to represent the at least one modified value of the jitter.

5. The method of claim 1, wherein modifying the resolution of the at least one frame comprises generating a set of low-resolution input images based on a sequence of jitter values.

6. The method of claim 5, wherein accessing the captured information comprises accessing captured information representing a plurality of frames, and wherein generating the set of low-resolution input images comprises generating a plurality of sets of low-resolution input images by iteratively:
applying a selected one of the sequence of jitter values to a corresponding one of the plurality of frames to generate a modified one of the plurality of frames; and
generating one of the plurality of sets of low-resolution input images for the modified one of the plurality of frames.

7. The method of claim 6, wherein the resolution of the at least one frame is a non-integer multiple of a modified resolution of one of the set of low-resolution input images, further comprising:
determining a plurality of additional jitters to map pixels in the at least one frame to pixels in the one of the set of low-resolution input images; and
adding the plurality of additional jitters to the selected one of the sequence of jitter values prior to generating a modified one of the plurality of frames.

8. The method of claim 1, wherein modifying the resolution of the at least one frame comprises generating a high-resolution ground truth image based on a sequence of jitter values.

9. The method of claim 8, wherein generating the high-resolution ground truth image comprises:
generating a plurality of modified images based on the at least one frame and the sequence of jitter values; and
combining the plurality of modified images to generate the high-resolution ground truth image.

10. An apparatus comprising:
a processing unit configured to:
access captured information representing at least one frame rendered by a game engine, wherein the captured information comprises commands and memory content for instructing a graphics processing unit (GPU) to replay the at least one frame;
identify at least one location in a memory associated with the GPU, wherein the at least one location is configured to store bits that represent jitter applied to the at least one frame by the game engine;
instruct the GPU to generate at least one modified frame by replaying the at least one frame based on the captured information and at least one modified value of the jitter; and
modify a resolution of the at least one frame based on the at least one modified frame.

11. The apparatus of claim 10, further comprising:
the GPU; and
the memory comprising bits stored at the at least one location, and wherein the bits represent a magnitude and a direction of the jitter.

12. The apparatus of claim 10, wherein the processing unit is configured to identify the at least one location based on at least one of a characteristic of shader code provided by the game engine, data shown by a graphics debugger operating on the captured information, or a characteristic of commands in the captured information.

13. The apparatus of claim 10, wherein the processing unit is configured to issue at least one memory modification command to modify the jitter to generate the at least one modified value of the jitter.

14. The apparatus of claim 10, wherein the processing unit is configured to generate a set of low-resolution input images based on a sequence of jitter values.

15. The apparatus of claim 14, wherein the processing unit is configured to access captured information representing a plurality of frames, and generate a plurality of sets of low-resolution input images by iteratively:
applying a selected one of the sequence of jitter values to a corresponding one of the plurality of frames to generate a modified one of the plurality of frames; and
generating one of the plurality of sets of low-resolution input images for the modified one of the plurality of frames.

16. The apparatus of claim 15, wherein the resolution of the at least one frame is a non-integer multiple of a modified resolution of one of the set of low-resolution input images, and wherein the processing unit is configured to:
determine a plurality of additional jitters to map pixels in the at least one frame to pixels in the one of the set of low-resolution input images; and
add the plurality of additional jitters to the selected one of the sequence of jitter values prior to generating a modified one of the plurality of frames.

17. The apparatus of claim 10, wherein the processing unit is configured to generate a high-resolution ground truth image based on a sequence of jitter values.

18. The apparatus of claim 17, wherein the processing unit is configured to:
generate a plurality of modified images based on the at least one frame and the sequence of jitter values; and
combine the plurality of modified images to generate the high-resolution ground truth image.

19. A non-transitory computer readable medium embodying a set of executable instructions, the set of executable instructions to manipulate at least one processor to:
access captured information representing at least one frame rendered by a game engine, wherein the captured information comprises commands and memory content for instructing a graphics processing unit (GPU) to replay the at least one frame;
identify at least one location in a memory associated with the GPU, wherein the at least one location is configured to store bits that represent jitter applied to the at least one frame by the game engine;
instruct the GPU to generate at least one modified frame by replaying the at least one frame based on the captured information and at least one modified value of the jitter; and
modify a resolution of the at least one frame based on the at least one modified frame.

20. The non-transitory computer readable medium of claim 19, wherein the set of executable instructions are configured to manipulate at least one processor to:
generate a set of low-resolution input images based on the captured information and a first sequence of jitter values and a high-resolution ground truth image based on the captured information and a second sequence of jitter values; and
train, based on the set of low-resolution input images and the high-resolution ground truth image, a machine learning (ML) engine to upscale low-resolution images provided to the ML engine.
